(19) United States
(12) Patent Application Publication
(10) Pub. No.: US 2019/0310856 A1
(43) Pub. Date: Oct. 10, 2019

(54) EXECUTING INSTRUCTIONS BASED ON A SHARED PHYSICAL REGISTER

(71) Applicant: INTERNATIONAL BUSINESS MACHINES CORPORATION, Armonk, NY (US)

(72) Inventors: Avraham Ayzenfeld, HOD HASHARON (IL); AMIR TURI, RAMAT GAN (IL); EYAL NAOR, Tel-Aviv (IL); Ido Rozenberg, Tel-Aviv (IL)

(21) Appl. No.: 15/948,220

(22) Filed: Apr. 9, 2018

(51) Int. Cl. G06F 9/38; G06F 9/30

(52) U.S. Cl. CPC G06F 9/3836; G06F 9/30098

(57) ABSTRACT

Embodiments of the present invention disclose a method, a computer program product, and a computer system for system for executing instructions, comprising a processor to detect a pair of destructive instructions within a predetermined number of instructions, wherein each instruction from the pair of destructive instructions assigns a value to be stored in a shared target logical register. In addition, the processor can also execute the pair of destructive instructions in an order received, wherein a result of each instruction of the pair of destructive instructions is mapped to a shared physical register. Furthermore, the processor can execute additional instructions based on the result of the pair of destructive instructions stored in the shared physical register.

### BACKGROUND

The present disclosure relates to executing instructions, and more specifically, but not exclusively, to executing instructions based on a shared physical register.

### SUMMARY

According to embodiments described herein, a system for executing instructions can include a processor to detect a pair of destructive instructions within a predetermined number of instructions, wherein each instruction from the pair of destructive instructions assigns a value to be stored in a shared target logical register. The processor can also execute the pair of destructive instructions in an order received, wherein a result of each instruction of the pair of destructive instructions is mapped to a shared physical register. Furthermore, the processor can execute additional instructions based on the result of the pair of destructive instructions stored in the shared physical register.

In embodiments, a method for executing instructions can include detecting a pair of destructive instructions within a predetermined number of instructions, wherein each instruction from the pair of destructive instructions assigns a value to be stored in a shared target logical register. The method can also include executing the pair of destructive instructions in an order received, wherein a result of each instruction of the pair of destructive instructions is mapped to a shared physical register. Furthermore, the method can include executing additional instructions based on the result of the pair of destructive instructions stored in the shared physical register.

In yet another embodiment, a computer program product for executing instructions can include a computer readable storage medium having program instructions embodied therewith, wherein the computer readable storage medium is not a transitory signal per se. The program instructions can be executable by a processor to cause the processor to detect a pair of destructive instructions within a predetermined number of instructions, wherein each instruction from the pair of destructive instructions assigns a value to be stored in a shared target logical register. The program instructions can also be executable by a processor to cause the processor to execute the pair of destructive instructions in an order received, wherein a result of each instruction of the pair of destructive instructions is mapped to a shared physical register. Additionally, the program instructions can be executable by a processor to cause the processor to execute additional instructions based on the result of the pair of destructive instructions stored in the shared physical register.

### BRIEF DESCRIPTION OF THE SEVERAL VIEWS OF THE DRAWINGS

The following detailed description, given by way of example and not intended to limit the invention solely thereto, will best be appreciated in conjunction with the accompanying drawings, in which:

FIG. 1 depicts a block diagram of an example computing system that can execute instructions based on a shared physical register according to an embodiment described herein;

FIG. 2 is a process flow diagram of an example method that can execute instructions based on a shared physical register according to an embodiment described herein;

FIG. 3A is an example of instructions executed without a shared physical register;

FIG. 3B is an example of instructions executed based on a shared physical register;

FIG. 4 is a tangible, non-transitory computer-readable medium that can execute instructions based on a shared physical register according to an embodiment described herein;

FIG. 5 depicts an illustrative cloud computing environment according to an embodiment described herein; and

FIG. 6 depicts a set of functional abstraction layers provided by a cloud computing environment according to an embodiment described herein.

### DETAILED DESCRIPTION

Central processing units (CPUs) can include any suitable number of general purpose registers that are used to execute instructions. For example, the general purpose registers can store retrieved data from any number of cache devices or memory devices. In some examples, the general purpose registers can also store the result of an operation. For example, the result of a mathematical operation, logical operation, and the like, can be stored in a general purpose register. In some embodiments, CPUs can execute instructions out of the order in which the instructions are received. For example, the CPU can read and decode a received instruction by mapping logical registers referenced in the instructions to physical general purpose registers. In some embodiments, CPUs can enable a physical register to release a result from a previously executed instruction.

In some embodiments, a device can assign multiple instructions to a single shared physical register, which can enable the execution of additional out of order instructions. For example, the device can detect a pair of destructive instructions within a predetermined number of instructions, wherein each instruction from the pair of destructive instructions assigns a value to be stored in a shared target logical register. A destructive instruction, as referred to herein, can include any instruction that is dependent on a previously executed instruction or supports a dependent instruction to be executed. For example, a destructive instruction can include an instruction that calculates a result which is used in subsequent instructions. Alternatively, a destructive instruction can include an instruction that calculates a value based on a source value previously calculated in another instruction. In some embodiments, the device can also execute the pair of destructive instructions in an order received, wherein a result of each instruction of the pair of destructive instructions is mapped to a shared physical register. For example, a first instruction can store a result of a calculation in the shared physical register and a second instruction can used the result in calculating a second result that overrides the result stored in the shared physical register. Furthermore, the device can execute additional instructions based on the result of the pair of destructive instructions stored in the shared physical register.

Accordingly, the techniques described herein can reduce the number of physical registers used to execute instructions. Therefore, the techniques described herein can prevent adding physical registers to a CPU, which would consume additional power and space. The techniques also enable executing a larger number of out of order instructions.

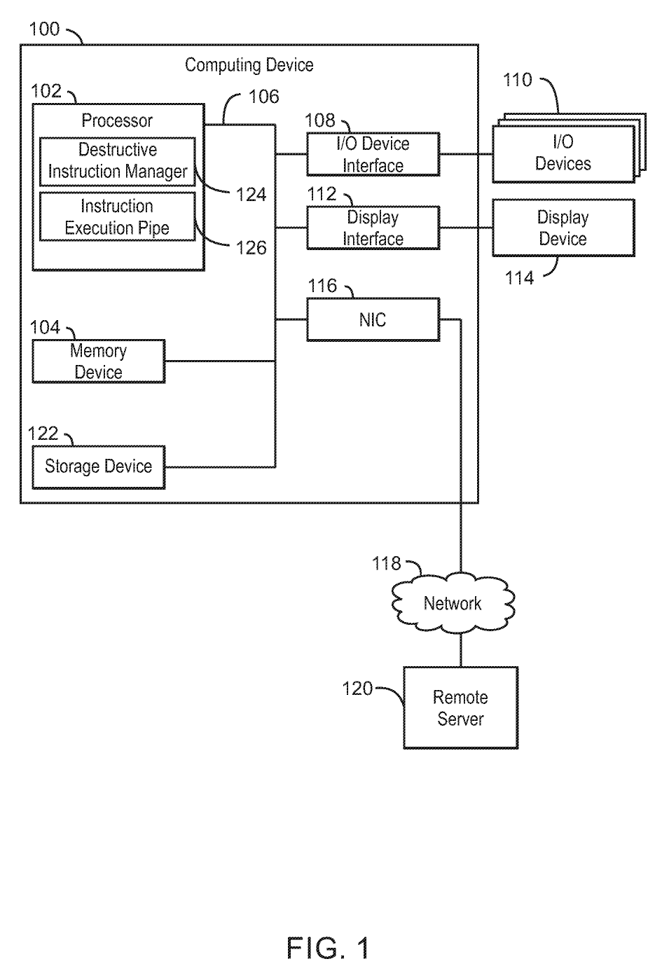

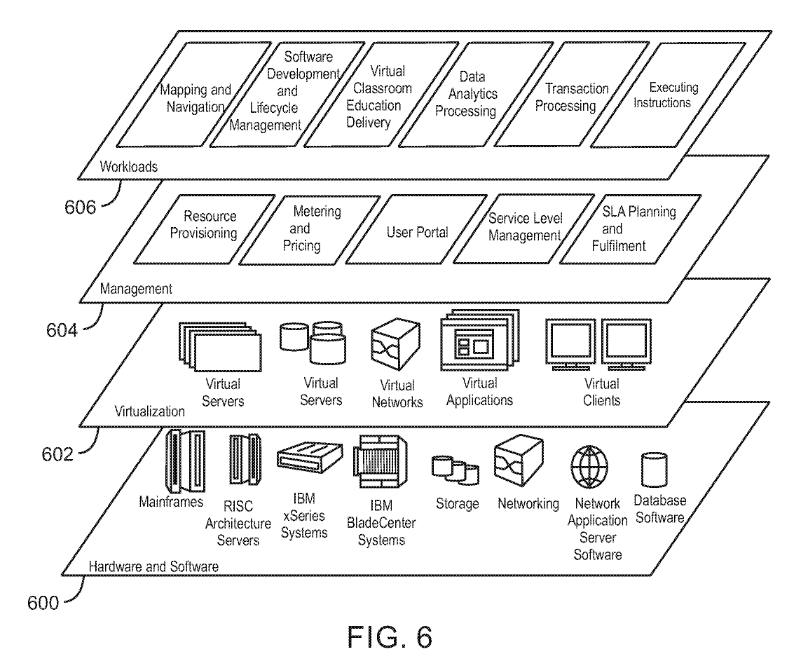

With reference now to FIG. 1, an example computing device is depicted that can execute instructions. The computing device 100 may be for example, a server, desktop computer, laptop computer, tablet computer, or smartphone. In some examples, computing device 100 may be a cloud computing node. Computing device 100 may be described in the general context of computer system executable instructions, such as program modules, being executed by a computer system. Generally, program modules may include routines, programs, objects, components, logic, data structures, and so on that perform particular tasks or implement particular abstract data types. Computing device 100 may be practiced in distributed cloud computing environments where tasks are performed by remote processing devices that are linked through a communications network, for example the cloud computing environment depicted by FIG. 6. In a distributed cloud computing environment, program modules may be located in both local and remote computer system storage media including memory storage devices.

The computing device 100 may include a processor 102 that is adapted to execute stored instructions, a memory device 104 to provide temporary memory space for operations of said instructions during operation. The processor can be a single-core processor, multi-core processor, computing cluster, or any number of other configurations. The memory device 140 can include random access memory (RAM), read only memory, flash memory, or any other suitable memory systems.

The processor 102 may be connected through a system interconnect 106 (e.g., PCI®, PCI-Express®, etc.) to an input/output (I/O) device interface 108 adapted to connect the computing device 100 to one or more I/O devices 110. The I/O devices 110 may include, for example, a keyboard and a pointing device, wherein the pointing device may include a touchpad or a touchscreen, among others. The I/O devices 110 may be built-in components of the computing device 100, or may be devices that are externally connected to the computing device 100.

The processor 102 may also be linked through the system interconnect 106 to a display interface 112 adapted to connect the computing device 100 to a display device 114. The display device 114 may include a display screen that is a built-in component of the computing device 100. The display device 114 may also include a computer monitor, television, or projector, among others, that is externally connected to the computing device 100. In addition, a network interface controller (NIC) 116 may be adapted to connect the computing device 100 through the system interconnect 106 to the network 118. In some embodiments, the NIC 116 can transmit data using any suitable interface or protocol, such as the internet small computer system interface, among others. The network 118 may be a cellular network, a radio network, a wide area network (WAN), a local area network (LAN), or the Internet, among others. A remote server 120 may connect to the computing device 100 through the network 118.

The processor 102 may also be linked through the system interconnect 106 to a storage device 122 that can include a hard drive, an optical drive, a USB flash drive, an array of drives, or any combinations thereof. In some examples, the storage device 122 may include data used to execute instructions by the processor 102. In some examples, the processor 102 can include a destructive instruction manager 124, an instruction execution pipe 126, and an instruction execution pipe 126. In some embodiments, the destructive instruction manager 124 can detect a pair of destructive instructions within a predetermined number of instructions, wherein each instruction from the pair of destructive instructions assigns a value to be stored in a shared target logical register. In some embodiments, the instruction execution pipe 126 can execute the pair of destructive instructions in an order received, wherein a result of each instruction of the pair of destructive instructions is mapped to a shared physical register. In some embodiments, the instruction execution pipe 126 can execute additional instructions based on the result of the pair of destructive instructions stored in the shared physical register.

It is to be understood that the block diagram of FIG. 1 is not intended to indicate that the computing device 100 is to include all of the components shown in FIG. 1. Rather, the computing device 100 can include fewer or additional components not illustrated in FIG. 1 (e.g., additional memory components, embedded controllers, modules, additional network interfaces, etc.). Furthermore, any of the functionalities of the destructive instruction manager 124, and instruction execution pipe 126 are partially, or entirely, implemented in hardware and/or in the processor 102. For example, the functionality may be implemented with an application specific integrated circuit, logic implemented in an embedded controller, or in logic implemented in the processor 102, among others. In some embodiments, the functionalities of the destructive instruction manager 124, and instruction execution pipe 126 can be implemented with logic, wherein the logic, as referred to herein, can include any suitable hardware (e.g., a processor, among others), software (e.g., an application, among others), firmware, or any suitable combination of hardware, software, and firmware.

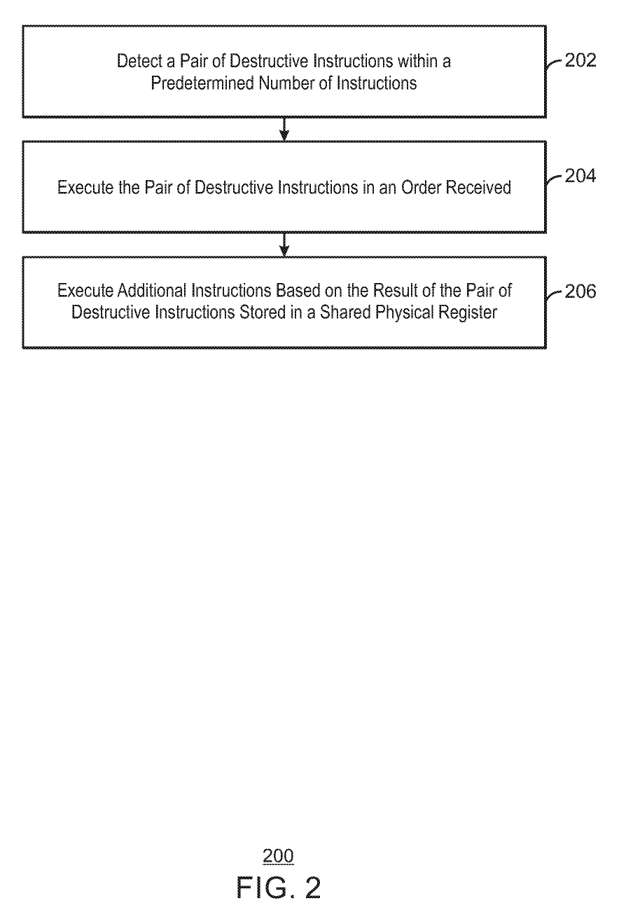

FIG. 2 is a process flow diagram of an example method that can execute instructions based on a shared physical register. The method 200 can be implemented with any suitable computing device, such as the computing device 100 of FIG. 1.

At block 202, the destructive instruction manager 124 can detect a pair of destructive instructions within a predetermined number of instructions, wherein each instruction from the pair of destructive instructions assigns a value to be stored in a shared target logical register. In some embodiments, a destructive instruction, as referred to herein, can include any instruction that is dependent on a previously executed instruction or supports a dependent instruction to be executed. For example, a destructive instruction can include an instruction that calculates a result which is used in subsequent instructions. Alternatively, a destructive instruction can include an instruction that calculates a value based on a source value previously calculated in another instruction. Accordingly, a pair of destructive instructions can include two instructions in which a first instruction corresponds to a calculation that depends on a value set by a previous second operation. For example, a pair of destructive instructions can include a first instruction that sets a value of a logical register R1 and the second instruction can include a mathematical operation that depends on the logical register R1 value determined by the first instruction. For example, the second instruction can include a mathematical operation setting the value of R1 based on an addition of R1 and any suitable additional value. Accordingly, the second instruction and the first instruction assign a value to a shared target logical register, e.g. R1. In some embodiments, the pair of destructive instructions comprise a first instruction and a second instruction, wherein the second instruction depends on the value stored in the shared physical register by the first instruction. In some examples, the first instruction and the second instruction comprise mathematical operations.

In some embodiments, the additional value is to be loaded into a physical register prior to execution of the second calculation. For example, the additional value may not be speculative, so the destructive instruction manager 124 can verify that the additional value is loaded from memory into a physical register prior to execution of the second instruction. Therefore, the second instruction comprises non-speculative source values stored in physical source registers. By contrast, speculative values loaded into physical registers correspond to memory addresses that have not been analyzed to determine if the speculative values are the actual requested values.

Additionally, in some embodiments, the predetermined number of instructions is limited based at least on a number of physical registers. In some embodiments, the pair of destructive instructions are consecutive instructions. In some examples, the pair of destructive instructions are separated by at least one non-destructive instruction. In some examples, the predetermined number of instructions is not based only on the number of physical registers, but also on the size of the instruction queue (e.g. hardware that stores instructions waiting to be executed), the number of threads (e.g. how many processes are running in parallel), and the like.

At block 204, the instruction execution pipe 126 can execute the pair of destructive instructions in an order received, wherein a result of each instruction of the pair of destructive instructions is mapped to a shared physical register. For example, the instruction execution pipe 126 may be executed by a processor that supports out of order instruction execution. For example, the processor may execute a group of instructions out of the order in which the instructions were received and store a result for each instruction in a separate physical register. Accordingly, a processor may in some instances store a result of a pair of destructive instructions in separate physical registers. For example, a processor may store a result from a first instruction in a first physical register and a result from a second instruction that depends from the first instruction in a second physical register. The instruction execution pipe 126 can modify the processor instruction set architecture to store the result from a first instruction and a second instruction in a pair of destructive instructions in the same shared physical register. Accordingly, in some embodiments, the instruction execution pipe 126 can modify a physical register assignment of the second instruction to store the result of the second instruction in the shared physical register, wherein the shared physical register previously stored the result of the first instruction.

At block 206, the instruction execution pipe 126 can execute additional instructions based on the result of the pair of destructive instructions stored in the shared physical register. For example, the instruction execution pipe 126 can cause a processor to execute additional instructions using the value stored in the shared physical register by the second instruction of a pair of destructive instructions. Accordingly, the instruction execution pipe 126 enables a processor to execute additional instructions without determining whether to use a stored value from a physical register corresponding to the first destructive instruction or a separate physical register corresponding to the second destructive instruction. Rather, additional instructions are executed based on the value stored in the shared physical register.

The process flow diagram of FIG. 2 is not intended to indicate that the operations of the method 200 are to be executed in any particular order, or that all of the operations of the method 200 are to be included in every case. In some embodiments, the method 200 includes executing non-destructive instructions using an out-of-order execution technique. A non-destructive instruction can include any instruction that is not dependent on a previous instruction. For example, any suitable mathematical or logical operation that can be executed regardless of the results calculated in previously executed instructions.

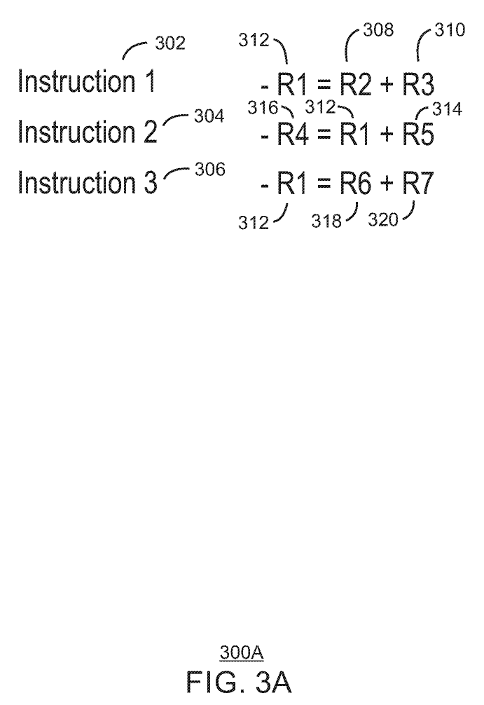

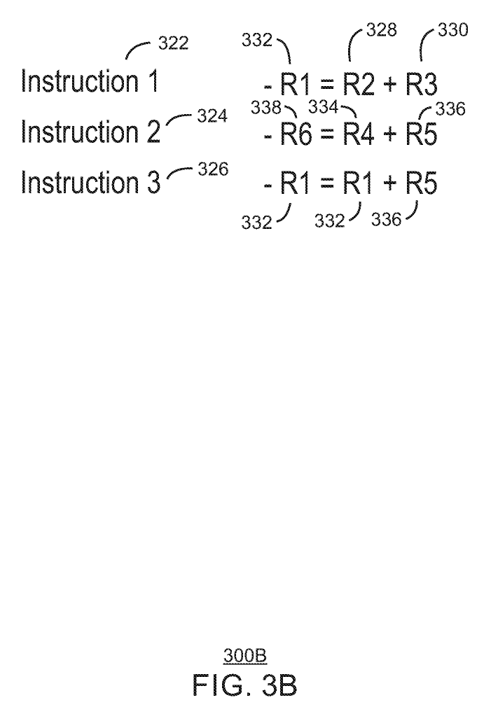

FIG. 3A is an example of instructions executed out of order without a shared physical register. For example, a processor can execute a set of instructions 300A that includes three instructions 302, 304, and 306. In some examples, the instruction 302 can include two source values in logical registers R2 308 and R3 310 that are used in a calculation and a result of the calculation is stored in a logical register R1 312.

In some embodiments, the instruction 304 can include two source values stored in logical register R1 312 and R5 314 and generate a result stored in logical register R4 316. The instruction 306 can include two source values or operands stored in logical register R6 318 and logical register R7 320. The result of instruction 306 can be stored in logical register R1 312.

Accordingly, instruction 306 is independent of the previous instructions 302 and 304. If instruction 304 is waiting for data from memory for logical register R5 314, instruction 306 can be executed before instruction 304. In this example, the order of execution will be instruction 302, instruction 306, and instruction 304. However, instruction 304 will get the wrong value of logical register R1 312 because instruction 304 will read the value that instruction 306 stored in logical register R1 312 rather than the value that instruction 302 stored in logical register R1 312. To prevent such an issue, a processor can implement register mapping, which maps each instance of a logical register to a separate physical register. For example, the first instance of logical register R1 312 in instruction 302 can be mapped to a first physical register, which instruction 302 will access. However, the instruction 306 will store a result for the instance of logical register R1 312 in a separate physical register, such as physical register 2, or any physical register distinct from the first physical register. Accordingly, if instruction 306 is executed before instruction 304, the result of instruction 306 stored in an instance of logical register R1 312 will not alter the result of instruction 304. Therefore, the processor can execute instruction 306 in any suitable order because instruction 306 is not dependent on instruction 302 or 304. Accordingly, the processor can execute instruction 306 before executing instruction 302, before executing instruction 304, or after executing instruction 304.

FIG. 3B is an example of instructions executed based on a shared physical register. For example, a processor can execute a set of instructions 300B that includes three instructions 322, 324, and 326. In some examples, the instruction 322 can include two source values in logical registers R2 328 and R3 330 that are used in a calculation and a result of the calculation is stored in a logical register R1 332.

In some embodiments, the instruction 324 can include two source values stored in logical registers R4 334 and R5 336 and generate a result stored in logical register R6 338. The processor can execute instruction 324 in any suitable order because instruction 324 is not dependent on instruction 322 or 326. Accordingly, the processor can execute instruction 324 before executing instruction 322, before executing instruction 326, or after executing instruction 326.

In some examples, the instruction 326 can include a mathematical or logical calculation that is dependent on instruction 322. For example, the instruction 326 can perform a calculation based on logical register R1 332 and an additional value stored in a logical register R5 336. The processor can store the result of the calculation of instruction 326 in logical register R1 332 rather than storing the result in a separate physical register. For example, the processor can assign a value stored in local register R1 332 on the left side of instruction 326 to a different physical register than the local register R1 of instruction 322. Therefore, two local registers can be used to store a value for a logical register R1 used in separate instructions. The use of two local registers is redundant and wasteful because instruction 326 is dependent on logical register R1 332 (the logical register appearing on the right hand side of instruction 326). Therefore, instruction 326 will be executed after instruction 322 due to the dependency. In addition, the instruction 324 is independent of logical register R1, so swapping the order of instruction 324 and 326 will not alter the result, even if the processor is to map both logical register R1 of instruction 322 and logical register R1 of instruction 326 to the same physical register. Thus, the present techniques add circuitry to a processor that determines if a register mapper can allocate a shared physical register for executing an instruction based in part on the dependency between the instructions being executed.

The sets of instructions 300A and 300B of FIGS. 3A and 3B are intended as examples and can include fewer or additional instructions. Additionally, the sets of instructions 300A and 300B can include any suitable combination of different logical registers corresponding to operands for each instruction.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

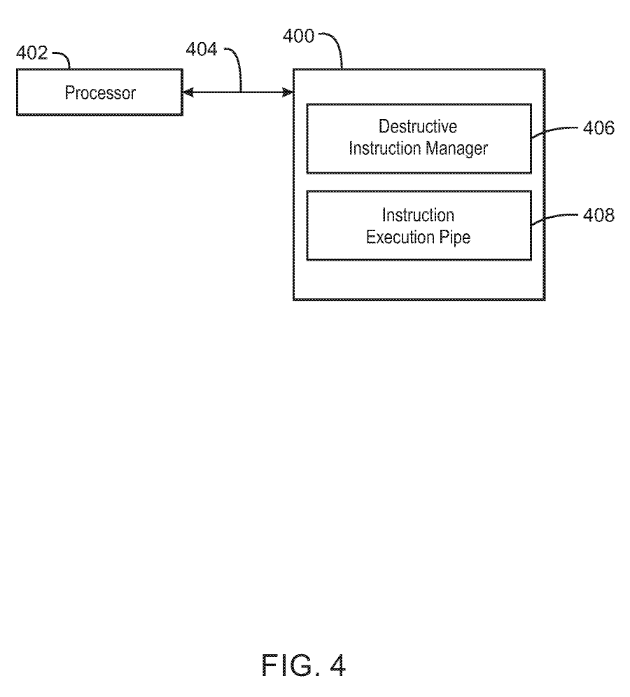

Referring now to FIG. 4, a block diagram is depicted of an example of a tangible, non-transitory computer-readable medium that can execute instructions based on a shared physical register. The tangible, non-transitory, computer-readable medium 400 may be accessed by a processor 402 over a computer interconnect 404.

Furthermore, the tangible, non-transitory, computer-readable medium 400 may include code to direct the processor 402 to perform the operations of the current method. For example, a destructive instruction manager 406 can detect a pair of destructive instructions within a predetermined number of instructions, wherein each instruction from the pair of destructive instructions assigns a value to be stored in a shared target logical register. In some embodiments, an instruction execution pipe 408 can execute the pair of destructive instructions in an order received, wherein a result of each instruction of the pair of destructive instructions is mapped to a shared physical register. In some embodiments, the instruction execution pipe 408 can execute additional instructions based on the result of the pair of destructive instructions stored in the shared physical register.

It is to be understood that any number of additional software components not shown in FIG. 4 may be included within the tangible, non-transitory, computer-readable medium 400, depending on the specific application. Furthermore, fewer software components than those shown in FIG. 4 can be included in the tangible, non-transitory, computer-readable medium 400.

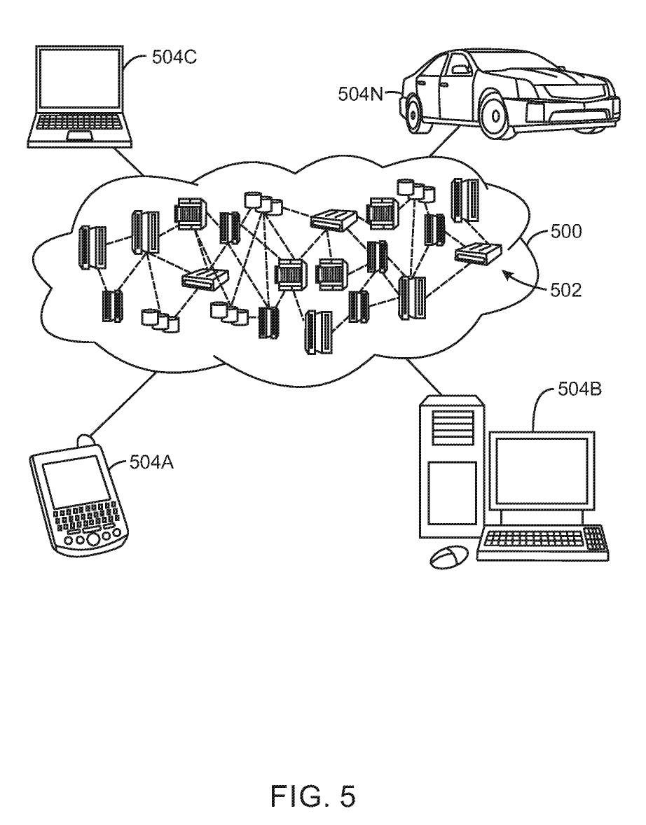

Referring now to FIG. 5, illustrative cloud computing environment 500 is depicted. As shown, cloud computing environment 500 comprises one or more cloud computing nodes 502 with which local computing devices used by cloud consumers, such as, for example, personal digital assistant (PDA) or cellular telephone 504A, desktop computer 504B, laptop computer 504C, and/or automobile computer system 504N may communicate. Nodes 502 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 504A-N shown in FIG. 5 are intended to be illustrative only and that computing nodes 502 and cloud computing environment 500 can communicate with any type of computerized device over any type of network and/or network addressable connection (e.g., using a web browser).

Referring now to FIG. 6, a set of functional abstraction layers provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided.

Hardware and software layer 600 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 602 provides an abstraction layer from which the following examples of virtual entities may be provided: virtual servers; virtual storage; virtual networks, including virtual private networks; virtual applications and operating systems; and virtual clients. In one example, management layer 604 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 606 provides examples of functionality for which the cloud computing environment may be utilized. Examples of workloads and functions which may be provided from this layer include: mapping and navigation; software development and lifecycle management; virtual classroom education delivery; data analytics processing; transaction processing; and executing instructions based on a shared physical register.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer system for executing instructions, the computer system comprising:
one or more processors, one or more computer-readable memories, one or more computer-readable tangible storage devices, and program instructions stored on at least one of the one or more computer-readable tangible storage devices for execution by at least one of the one or more processors via at least one of the one or more computer-readable memories, the program instructions causing the one or more processors to:
detect a pair of destructive instructions within a predetermined number of instructions, wherein each instruction from the pair of destructive instructions assigns a value to be stored in a shared target logical register;
execute the pair of destructive instructions in an order received, wherein a result of each instruction of the pair of destructive instructions is mapped to a shared physical register; and
execute additional instructions based on the result of the pair of destructive instructions stored in the shared physical register.

2. The computer system of claim 1, wherein the pair of destructive instructions comprise a first instruction and a second instruction, wherein the second instruction depends on the value stored in the shared physical register by the first instruction.

3. The computer system of claim 2, wherein the second instruction comprises non-speculative source values stored in physical source registers.

4. The computer system of claim 2, wherein the processor modifies a physical register assignment of the second instruction to store the result of the second instruction in the shared physical register, wherein the shared physical register previously stored the result of the first instruction.

5. The computer system of claim 1, wherein the predetermined number of instructions is limited based at least on a number of physical registers.

6. The computer system of claim 2, wherein the first instruction and the second instruction comprise mathematical operations.

7. The computer system of claim 1, wherein the processor executes non-destructive instructions using an out-of-order execution technique.

8. The computer system of claim 1, wherein the pair of destructive instructions are consecutive instructions.

9. The computer system of claim 1, wherein the pair of destructive instructions are separated by at least one non-destructive instruction.

10. A method for executing instructions, the method comprising:
detecting a pair of destructive instructions within a predetermined number of instructions, wherein each instruction from the pair of destructive instructions assigns a value to be stored in a shared target logical register;
executing the pair of destructive instructions in an order received, wherein a result of each instruction of the pair of destructive instructions is mapped to a shared physical register; and
executing additional instructions based on the result of the pair of destructive instructions stored in the shared physical register.

11. The method of claim 10, wherein the pair of destructive instructions comprise a first instruction and a second instruction, wherein the second instruction depends on the value stored in the shared physical register by the first instruction.

12. The method of claim 11, wherein the second instruction comprises non-speculative source values stored in physical source registers.

13. The method of claim 11, further comprising modifying a physical register assignment of the second instruction to store the result of the second instruction in the shared physical register, wherein the shared physical register previously stored the result of the first instruction.

14. The method of claim 10, wherein the predetermined number of instructions is limited based at least on a number of physical registers, a size of an instruction queue, and a number of threads.

15. The method of claim 11, wherein the first instruction and the second instruction comprise mathematical operations.

16. The method of claim 10, further comprising executing non-destructive instructions using an out-of-order execution technique.

17. The method of claim 10, wherein the pair of destructive instructions are consecutive instructions.

18. The method of claim 10, wherein the pair of destructive instructions are separated by at least one non-destructive instruction.

19. A computer program product for executing instructions, the computer program product comprising:
one or more computer-readable storage devices and program instructions stored on at least one of the one or more computer-readable storage devices, the program instructions causing the processor to:
detect a pair of destructive instructions within a predetermined number of instructions, wherein each instruction from the pair of destructive instructions assigns a value to be stored in a shared target logical register;
execute the pair of destructive instructions in an order received, wherein a result of each instruction of the pair of destructive instructions is mapped to a shared physical register; and
execute additional instructions based on the result of the pair of destructive instructions stored in the shared physical register.

20. The computer program product of claim 19, wherein the program instructions cause the processor to modify a physical register assignment of the second instruction to store the result of the second instruction in the shared physical register, wherein the shared physical register previously stored the result of the first instruction.
